(19) United States
(12) Patent Application Publication
(10) Pub. No.: US 2006/0000544 A1
(43) Pub. Date: Jan. 5, 2006

(54) Method of producing cartons

(75) Inventor: Robert J. Hunter, Woodstock, GA (US)

Correspondence Address: WOMBLE CARLYLE SANDRIDGE & RICE, P.O. Box 7037, Atlanta, GA, 30357-0037, US

(73) Assignee: Riverwood International Corporation

(21) Appl. No.: 10/780,777

(22) Filed: Feb. 17, 2004

Related U.S. Application Data
(60) Provisional application No. 60/535,225, filed on Jan. 9, 2004.

(51) Int. Cl. B32B 37/15

(52) U.S. Cl. 156/244.11; 156/443; 156/500

(57) ABSTRACT

A process for forming cartons in which one or more reinforcing strips are laminated or adhered to a carton material using an extruded foamed adhesive or folded carton. Typically, the foamed adhesive is a water-based emulsion and applied in strips in either a continuous or non-continuous manner onto strips or substrates.

### FIELD OF THE INVENTION

The present invention generally relates to the manufacture of cartons, and in particular, to a method of forming a reinforced carton blank having an extruded foamed adhesive applied to paperboard carton materials for laminating a reinforcing material thereto and/or for attaching folded edges or portions of the carton material to form an enclosed carton.

### BACKGROUND OF THE INVENTION

Paperboard cartons typically are formed from laminated paperboard blanks stamped or cut from sheets of a carton material and processed through a packaging machine. The laminated paperboard blanks further can have a reinforcing strip affixed thereto typically by the application of an adhesive. The laminated paperboard blanks may then be further processed into cartons by cutting carton blanks and/or folding and gluing the blanks into cartons for loading with products. The typical carton also includes flaps, which are folded closed and sealed.

Currently, the process for laminating paperboard carton materials together for forming carton blanks generally involves roll to roll, roll to sheet, or sheet to sheet processes using a liquid adhesive. The liquid adhesive typically is applied to a web of paperboard material either by rolling, extruding, or spraying the adhesive onto the web, over which an additional web or strips of material are applied. The laminated material is then allowed to set and the adhesive is allowed to cure before the laminated material can be transferred to a cutting line for die cutting carton blanks from the laminated carton material. Typically, cold set adhesives are chosen given their low cost and ability to provide significant high/low temperature bonding qualities. Such cold set adhesives typically do not degrade or breakdown when exposed to high heats or freezing temperatures, Additionally, cold set adhesives tend to maintain their adhesion and resist cracking and breaking during handling. Unfortunately, the elevated moisture content of such cold set adhesives requires a substantial amount of time to set and cure and can cause warping of the paperboard cartons due to the elevated amount of moisture applied to the paperboard from the liquid adhesive, and further can flow or be easily squeezed out from between the mating carton surfaces as pressure is applied.

Accordingly, it can be seen that a need exists for a process and system of forming laminated carton blanks that addresses the foregoing and other related problems in the art.

### SUMMARY OF THE INVENTION

Briefly, described, the present invention generally is directed to a system and method for forming reinforced cartons and/or attaching folded carton flaps or sections to form enclosed cartons. In a first embodiment for forming reinforced cartons, a substrate of a reinforcing material is adhered to a carton material by application of an extruded foamed adhesive along a processing line or path as part of a single, substantially continuous operation. Typically, the reinforcing material, which can include strips or a full size web of paperboard, thermoplastics or other natural or synthetic reinforcing materials, will be fed along a processing path from an upstream supply toward registration and engagement with a carton material such as a paperboard or cardboard web or sheet material. The reinforcing material strips or web are initially passed ajacent an extrusion head that applies a measured amount of a foamed adhesive along a surface of the reinforcing material strips, or web in desired pattern and/or at spaced locations across the reinforcing material, including along outer side edges of the reinforcing strips or web.

After the foamed adhesive has been applied to the reinforcing material strips or web, the carton material is fed into engagement with the reinforcing material strips or web. The reinforcing material strips or web and carton material are then passed through a laminating station. The laminating station typically includes at least one pair of nip or compression rollers that compress or otherwise urge the reinforcing material strips or web and the carton material into tight, adhesive contact. Thereafter, the carton material with the reinforcing material strips or web laminated thereto is passed into a cutting station for cutting sheets or carton blanks for forming reinforced cartons.

In an additional embodiment of the present invention, the foamed adhesive applicator station can be incorporated or substituted for the adhesive application station of a folder/gluer line for forming enclosed cartons. In such an embodiment, the foamed adhesive extrusion heads will be positioned adjacent the tucking or folding elements or systems, i.e., belts, wheels, fingers, etc., of the folder/gluer line and will apply the foamed adhesive in measured amounts and/or at spaced locations along the carton flaps being folded together, including along the underside edges thereof. Thereafter, the flaps will be pressed into tight adhesive contact, so as to hold the folded carton sections or flaps tightly together and prevent picking or separation of the flaps along the edges thereof. Still further, the present invention can be used for the application of both a cold set foamed adhesive and a hot melt adhesive to provide immediate adhesion of the carton sections or flaps together for loading and handling of the enclosed cartons as the cold set adhesive is cured.

Various objects, features and advantages of the present invention will become apparent to those skilled in the art upon reading the following specification when taken in conjunction with the accompanying drawings.

### BRIEF DESCRIPTION OF THE DRAWINGS

FIG. 1 is view schematically illustrating the process for forming reinforced carton blanks according to the present invention.

FIG. 2 depicts the extrusion head applying the foamed adhesive to the carton substrate.

FIG. 3 illustrates one configuration of the extrusion head for applying the foamed adhesive.

FIG. 4 depicts the extrusion head in communication with the carton blank.

FIG. 5 schematically illustrates an embodiment of the apparatus for applying the foamed adhesive and forming the reinforced blank.

FIG. 6A is a schematic illustration of the process of the present invention for applying the foamed adhesive to folded carton flaps along a folder/gluer line.

FIG. 6B is a schematic illustration of the compression belts of the process of FIG. 6A.

### DETAILED DESCRIPTION

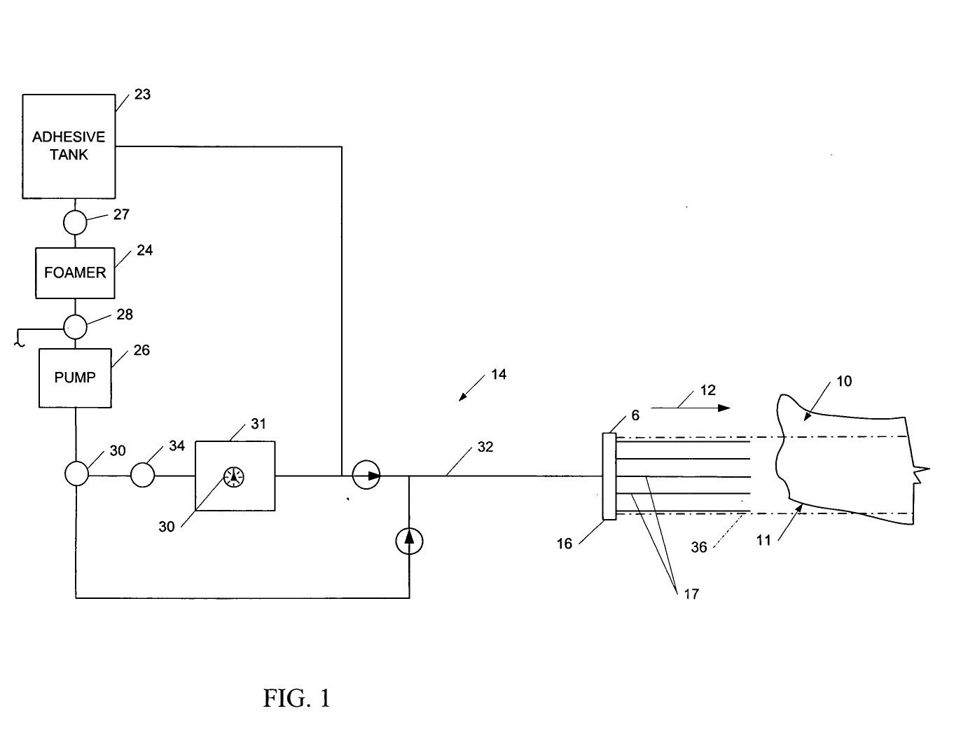

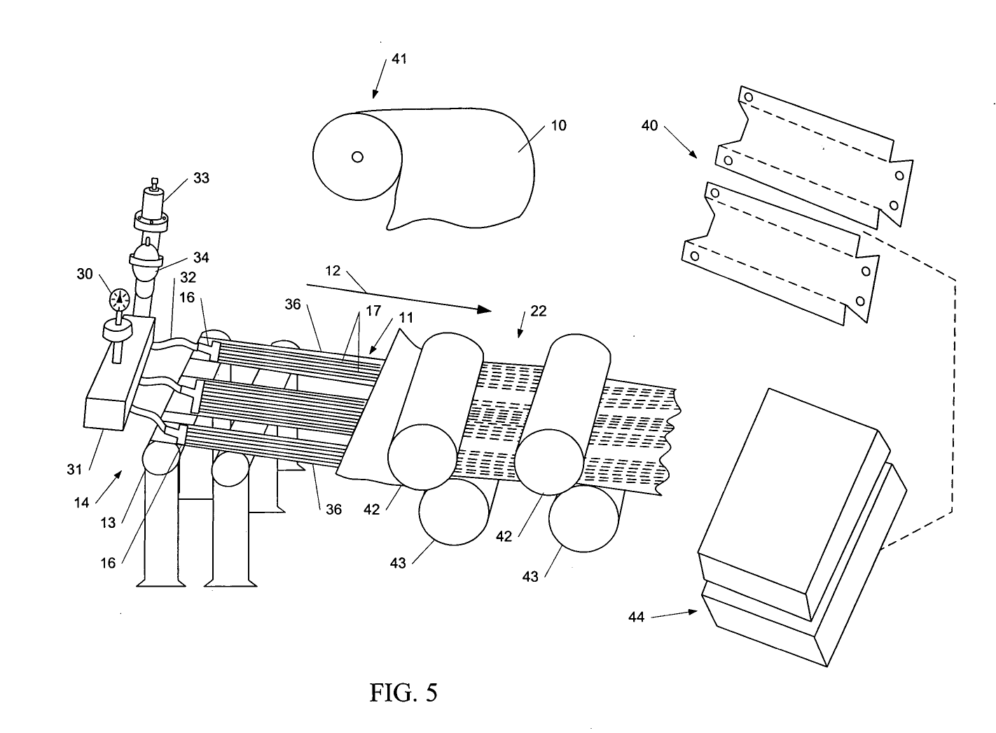

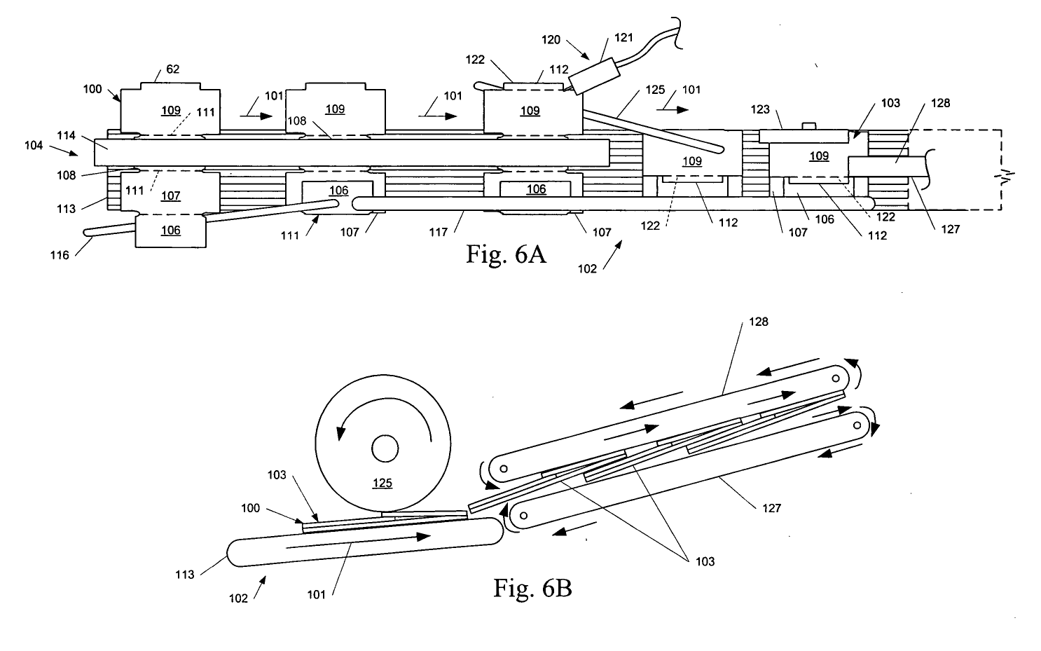

Referring now in greater detail to the drawings, in which like numerals indicate like parts throughout the views, FIGS. 1, 5 and 6 schematically illustrate the process of the present invention for forming reinforced cartons and/or closing cartons by the application of a foamed, extruded adhesive between folded portions of a carton material 10 (FIG. 6) and/or between the carton material 10 and a reinforcing material 11 (FIGS. 1 and 5), which process can be performed in a substantially continuous operation. The carton material generally is formed from a paperboard material, or can include other types of natural and synthetic carton materials including cardboard, various plastic materials, etc. The use of the foamed adhesive in the present invention enables a reduction in the amount of adhesive applied, which consequently reduces the water content applied to paperboard carton materials, reducing incidences of warping and enabling shorter, faster cure times, as well as enabling greater precision in the application of the adhesive in desired patterns and/or during compression.

The foamed adhesive may be a water-based emulsion adhesive to which air is added under pressure to cause foaming of the adhesive. Examples of such water-based adhesives include, but are not limited to, ethylene vinyl acetate (“eva”) and polyvinyl acetate (“pva”) adhesives. The viscosity of the foamed adhesive may be in the range between about 300 to about 1000 centipoise at room temperature. If the foamed adhesive is fixatropic, the viscosity may range up to about 7000 centipoise at room temperature. Of course, the viscosity of the foamed adhesive may be chosen from any range that would allow the foamed adhesive to be extruded while substantially remaining in a fixed pattern when applied to the substrate. The foamed adhesive further may include bubbles having a diameter between about 20 to about 40 microns after being mixed with air, which consequently expands the volume of the extruded adhesive, allowing less adhesive to be used to obtain the desired coverage. Further, the foamed adhesive tends to flatten during compression as air bubbles are urged from the foamed adhesive, rather than being squeezed out from between the material edges as with conventional liquid adhesives.

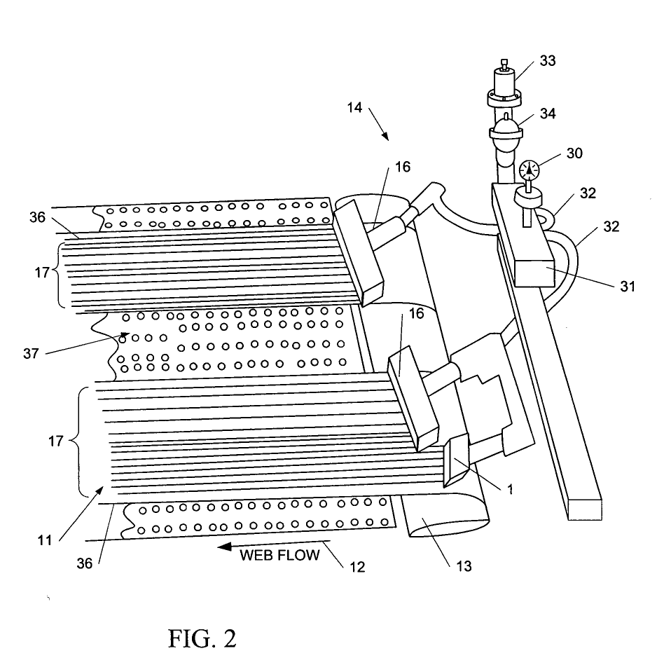

In one example embodiment shown in FIGS. 1-5, the process of the present invention can be used for the application of a reinforcing material substrate 11 to a carton material web or sheet 10. In such a process, a strip or web of reinforcing material will be fed along a processing line in the direction of arrow and over rollers 13 (FIGS. 2 and 5) and into an adhesive applicator station 14 wherein the reinforcing material passes adjacent extrusion heads 16 of the adhesive applicator station 14. As shown in FIG. 2, the extrusion heads 16 will apply an extruded, foamed adhesive to the reinforcing material strips or web, with the foamed adhesive being applied in most any pattern and at desired locations across the strips or web. For example, the foamed adhesive may be laid down in substantially straight parallel lines 17 as depicted in FIG. 1 or the foamed adhesive may be laid down in wave-like patterns. Additionally, the foamed adhesive may be applied in a continuous manner such as in stripes or measured amounts or portions.

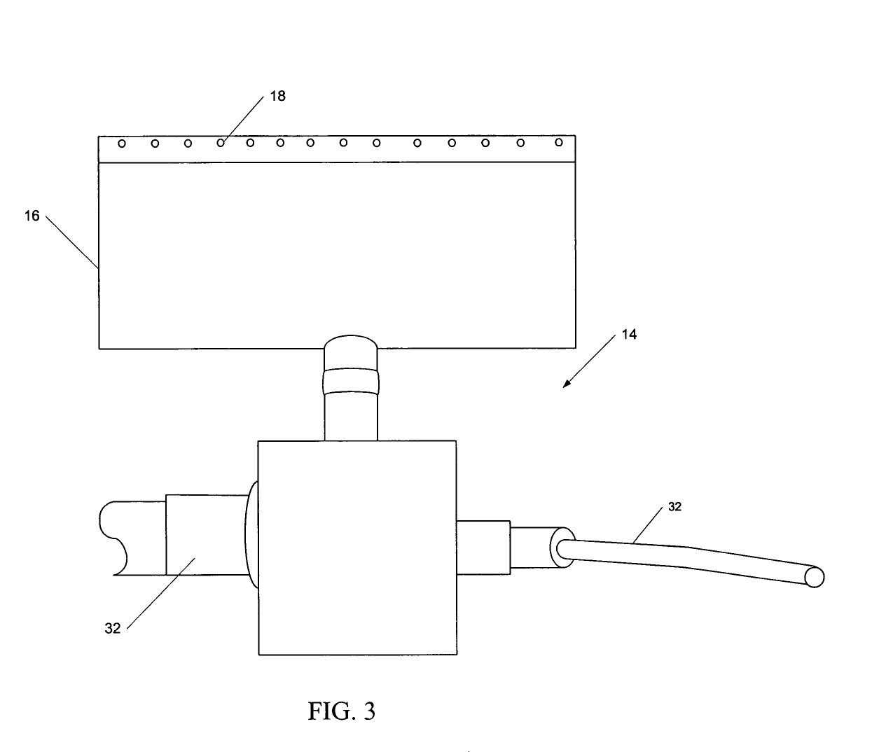

As indicated in FIG. 3, the extrusion heads 16 will include one or more orifices or ports 18. The orifices 18 typically have a diameter between about 0.01 to about 0.1 inches, although lesser or greater sizes also can be used. The orifices may take the form of most any geometric shape but typically are circular in nature. The orifices 18 generally are aligned in essentially a straight line in the same plane, although other, varying configurations also can be used as desired. Further, although the orifices 18 typically are round and similar in size as shown in FIG. 3, the orifices 18 need not be uniform in size or shape, but rather can be formed in varying sizes and configurations or shapes. Depending upon the adhesive pattern desired to be placed on the reinforcing material, the orifices 18 also may be spaced at different intervals and have different shapes and sizes. A combination of one or more extrusion heads also may be used in the application of the foamed adhesive to one or more substrates. Extrusion is defined herein as the passing of a foamed adhesive through an orifice under a certain pressure.

As shown in FIG. 1 in this first example embodiment of the process including the apparatus for applying the foamed adhesive to a reinforcing material 11 for attaching to carton materials 10, an example apparatus for performing such process generally will comprise a foaming station 21, the adhesive applicator station 14, and a laminating station 22. The foaming station 21 typically includes an adhesive storage or holding tank 23 for storing a supply of liquid adhesive. The tank 23 is connected to a foamer 24 that is fluidly attached to the adhesive applicator station 14 that includes one or more extrusion heads 16 for applying the foamed adhesive. The foamer 24 introduces air under pressure into the liquid adhesive as it is drawn or pumped from the holding tank 23 via a pump 26. Typically, the liquid adhesive also will be filtered by a filter 27 positioned between the holding tank 23 and the pump 26. A bypass valve 28 also may also be fitted between the pump 26 and roamer 24 to direct or bleed off excess adhesive flow from the tank to the adhesive applicator station 14. Additionally, various check valves may be placed in the system for regulating the flow of the extruded, foamed adhesive.

A pressure regulator 30 generally will be placed along the flow line between the foamer 24 and a plenum or distribution module 31, such as on the plenum 31, for the adhesive applicator station 14 for regulating the pressure of the flow of foamed adhesive in the system being supplied to the extrusion heads 16 through hoses or feed lines 32. Typically, the line pressure of the system is kept at about 60 psi to about 100 psi, or in an alternative embodiment, between 75 psi and 85 psi. Of course, this pressure may be greater or lesser and will vary depending upon the type of foamed adhesive used and the type of extrusion heads 16 chosen. The pressure of the adhesive flow is monitored and displayed via a pressure gauge 33 mounted along the distribution module. A shock suppressor 34 may also be added to the system and located between the foamer 24 and distribution module 31 for preventing or suppressing surges in the flow of the foamed adhesive being pumped or fed to the extrusion heads 16.

FIG. 2 illustrates the reinforcing material substrate 11, here shown as a series or reinforcing strips 36 being fed or wound around roller 13 and being conveyed along their processing path 12 by a vacuum belt or conveyor 37, wherein the foamed adhesive is applied to the strips 36 via the extrusion heads 16. FIG. 2 also shows both the use of a single extrusion head 16 applying the foamed adhesive to a single strip, as well as multiple extrusion heads applying the foamed adhesive to a second single strip or web. Varying combinations and configurations of different size extrusion heads also can be used as needed or desired for applying desired patterns and/or amounts of adhesive and/or applying the adhesive at desired locations. The foamed adhesive also is shown as essentially being applied in substantially straight parallel lines 17; however, other varying patterns also can be applied.

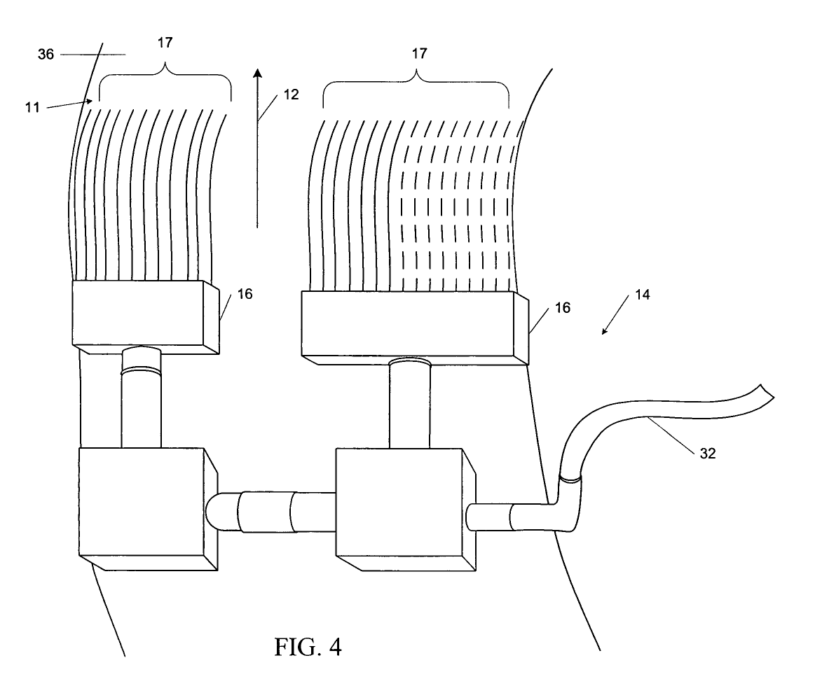

FIG. 4 further illustrates an arrangement of multiple extrusion heads 16 in contact with the reinforcing material substrate. Each extrusion head 16 may take on any form and is not limited to those depicted in the drawings so long as the foamed adhesive may be extruded onto the reinforcing material substrate. In addition, the different extrusion heads further can be controlled separately so as to apply different patterns and/or varying amounts of foamed adhesive to the reinforcing material substrate. For example, instead of continuous lines of adhesive being applied across the reinforcing material substrate, broken lines or dots of the foamed adhesive can be applied at selected locations where less adhesive may be needed. Still further, the use of different extrusion heads also enables the use or application of different foamed adhesive materials, as well as the application of both hot melt adhesive and a cold set adhesive to provide immediate adhesion of the carton and reinforcing materials for cutting and handling while the cold set adhesive is cured and to provide greater resistance to temperature extremes, as disclosed and claimed in co-pending, U.S. patent application Ser. No. ______, the disclosure of which is hereby incorporated by reference.

FIG. 5 illustrates in further detail the process of forming reinforced carton blanks 40 in which reinforcing material substrate 11, shown here as strips 36, generally is fed from a supply (not shown) into the adhesive applicator station 14. The reinforcing material substrate, like the carton material 10, typically will be formed from paperboard or cardboard materials, but also can be formed from other types of reinforcing materials, including plastic and/or other synthetic or natural materials, as will be understood by those skilled in the art. The reinforcing material also can include a web of approximately equivalent length to the carton material or can include one or more smaller rolls of reinforcing material that are precut to a desired width as needed for forming the reinforcing strips. These precut strips generally will be fed directly from their supply roll(s), although it also will be understood by those skilled in the art that a slitting station may also be used upstream of the adhesive applicator station to slit the strips from a single supply roll.

The reinforcing strips are moved along their processing path 12 and over cylinders or rollers 13 as the strips pass through the foamed adhesive applicator station 14. At the foamed adhesive applicator station 14, the foamed, extruded adhesive is applied to the reinforcing material strips in a desired pattern and at spaced locations across the width of the reinforcing material strips, including along the side edges of the reinforcing material strips as shown in FIGS. 2, 4 and 5. Placement of the adhesive along the edges of the strips is enabled by the use of foamed adhesive, which includes air bubbles formed therein such that, upon compression, air will be released or forced from the adhesive, allowing it to be compressed, rather than the adhesive being squeezed out from between the side edges of the reinforcing and carton materials.

A sheet of carton material 10 then will be fed from a supply 41 (FIG. 5) into an overlying relationship over the reinforcing material strips having the applied foamed adhesive. As the carton material and reinforcing strips are brought into registration, they are passed through the laminating station 22, which generally includes one or more pairs of compression or nip rolls 42 and 43. As the carton material and reinforcing strips are passed between the nip rolls, the nip rolls engage and apply a sufficient compression force to squeeze or compress the reinforcing strips and carton material together into adhesive contact. Additionally, a cutting station 44 can be provided downstream for forming the carton blanks 40 from the laminated material. The carton forming blank and cutting process is further described in copending published U.S. Patent Application U.S. 20010048022A1, which is incorporated herein in its entirety.

FIGS. 6A and 6B illustrate a further application of the principles of the present invention for applying a foamed adhesive material to a series of carton blanks 100 moving along a path of travel 101 through a folder/gluer line or system 102 (FIG. 6A) to form cartons 103. As indicated in FIG. 6A, each of the carton blanks are initially received at an upstream end 104 of the folder/gluer line 102 in a flat, unfolded configuration, with each carton blank typically having a series of panels, such as panels 106, 107, 108, and 109, generally separated by fold lines indicated by dashed lines 111. It will be understood by those skilled in the art that while a blank with four panels has been shown for purposes of illustration, various other types of carton blanks having varying numbers of panels also can be used, including carton blanks with less or greater than four folding panels. One of the end panels 109 further typically includes a tab or flange portion 112 projecting laterally therefrom.

The carton blanks 100 are moved along their path 101 on a series of travel or conveyor belts, including lower belt 113 and upper belt 114 that generally engages an upper surface of at least one of the panels, such as 108, so as to pull the carton blanks forwardly along their path of travel 101 as indicated in FIG. 6A. As the carton blanks are moved along the folder/gluer line 102, a first end panel 106 generally is engaged and moved upwardly and over its adjacent panel 107, being folded along the fold line 111 between panel 106 and panel 107 by engagement with a first folder mechanism 116. The first folder mechanism 116 typically includes one or more bars, rods, or plates that extends adjacent the path of travel of the carton blanks along the folder/gluer line in a position such that as the carton blanks are pulled along the folder/gluer line, their outer panels 106 will engage and ride along the folder mechanism so as to cause the outer panels to be folded over into a substantially flat, overlying configuration on top of the upper surface of adjacent panel 107.

After the first outer panel 106 has been folded into a flat position lying on top of its adjacent panel 107, the panel 106 generally will be further engaged by a compression belt 117 extending along the path of travel of the carton blanks. The compression belt 117 applies a compression force against the folded panels to maintain panel 106 in its substantially flat folded condition on top of panel 107. At about the same time, the carton blanks typically will be passed adjacent an adhesive applicator station 120, which typically includes one or more application or extrusion heads 121.

The adhesive applicator station 120 generally is substantially the same as the adhesive applicator station 14 discussed above with respect to FIGS. 1, 2 and 5 and receives a foamed, extruded cold-set adhesive material from a supply, which is applied in a desired pattern along the flange 112 of panel 109 of each carton blank 100. It will, however, be understood by those skilled in the art that while a single extrusion head 121 has been shown, multiple extrusion heads can be used for applying the foamed, extruded adhesive material at desired points along the carton blanks as needed for folding and gluing of various flaps or panels for different carton blank designs. For example, some carton blanks/cartons can have upwards of 20 or more points or areas at which the adhesive typically will be applied. Additionally, the foamed adhesive material is generally a foamed, cold-set adhesive, typically an EVA or PVA adhesive, although other types of adhesive materials, including hot melt adhesives, also can be used as discussed above.

As further illustrated in FIG. 6A, after the adhesive material 122 has been applied along its flange 112, each carton blank will pass into engagement with a second folder mechanism 125. As with the first folder mechanism, the second folder mechanism 125 generally will include a guide rod or plate that extends along and over the folder/gluer line 102. As a result, as the cartons engage the second folder mechanism, their panels 109 are progressively folded over into a flat lying configuration on top of panels 108, 107, and previously folded panel 106. The folded cartons then typically are engaged by a compression mechanism such as a wheel 126, although belts or other similar mechanisms can be used to apply a compression force along the fold line between panels 108 and 109 to help hold panel 109 in its folded, flat lying configuration to form a carton 103. Thereafter, each carton is passed into engagement with a series of take-off or compression belts 127 and 128, as illustrated in FIG. 6B. The compression belts 127 generally engage and pick up the cartons with the cartons held in a shingled arrangement so as to maintain the cartons in their flat folded configurations as the cartons pass between the compression belts for setting the foamed, extruded adhesive material and thus form the finished cartons 103.

It will be understood by those skilled in the art that while the present invention has been discussed above with respect to various preferred embodiments and/or features thereof, numerous changes, modifications, additions and deletions can be made thereto without departing from the spirit and scope of the invention as set forth in the following claims.

What is claimed is:

1. A method of forming a reinforced carton blank, comprising:
moving at least one strip of reinforcing material along a processing path;
extruding a foamed adhesive onto the at least one strip of reinforcing material in a desired pattern;
moving a carton material into registration with the at least one strip of reinforcing material; and
forming the carton blank from the attached carton material and at least one strip of reinforcing material.

2. The method of claim 1, wherein the foamed adhesive is a water-based emulsion.

3. The method of claim 2, wherein the foamed adhesive emulsion is selected from the group consisting essentially of ethylene vinyl acetate and polyvinyl acetate emulsions.

4. The method of claim 1, wherein the foamed adhesive is extruded in a discontinuous pattern.

5. The method of claim 1, wherein moving the carton material into registration with the at least one strip of reinforcing material includes feeding the carton material into contact with the at least one strip of reinforcing material and urging the carton material and at least one strip of reinforcing material together to set the adhesive for holding the carton material and at least one strip of reinforcing material together.

6. The method of claim 1, wherein urging the paperboard web and at least one strip of reinforcing material together includes passing the paperboard web and at least one strip of reinforcing material through compression rollers.

7. A method of forming reinforced carton blanks, comprising:
moving a reinforcing material and a carton material along a processing path toward engagement with each other;
extruding a foamed adhesive in a desired pattern between the reinforcing material and the carton material;
adhering the reinforcing material and carton material together to form a laminated reinforced carton material; and
cutting the carton blanks from the laminated reinforced carton material as it continues along the processing path.

8. The method of claim 7, wherein the foamed adhesive is a water-based emulsion.

9. The method of claim 8, wherein the foamed adhesive emulsion is selected from the group consisting essentially of ethylene vinyl acetate and polyvinyl acetate emulsions.

10. The method of claim 7, wherein the foamed adhesive is extruded in a discontinuous pattern.

11. A system for producing cartons, comprising:
a supply of a carton material along a processing path;
a foamed adhesive applicator station positioned along the processing path for applying an extruded foamed adhesive to the carton material in a desired pattern; and
a laminating station downstream from the foamed adhesive applicator station and adapted to engage and urge the carton material into contact with folded portions of the carton material or with reinforcing material strips being applied to carton material to form a laminated carton material and/or folded and enclosed cartons.

12. The system of claim 11, wherein the laminating station includes at least one pair of compression rolls or belts.

13. The system of claim 11 and further comprising a cutting station for forming the carton blanks from the laminated material.

14. The system of claim 11, further including a foaming station fluidly connected to the foamed adhesive applicator station for supplying the foamed adhesive to the extrusion head station.

15. The system of claim 14, wherein the foaming station includes a storage tank supplying an adhesive to a foamer.

16. The system of claim 11, wherein the foamed adhesive is a water-based emulsion.

17. The system of claim 16, wherein the foamed adhesive emulsion is selected from the group consisting essentially of ethylene vinyl acetate and polyvinyl acetate emulsions.

18. A system for producing reinforced carton blanks comprising:
a supply of reinforcing material strips fed along a processing path toward engagement with a carton material;
a foaming station fluidly connected to a foamed adhesive applicator station for applying a foamed adhesive to the reinforcing material strips;
a laminating station downstream from the foamed adhesive applicator station adapted to engage and urge the reinforcing material strips and a carton material into contact so that the strips and carton material are held together to form a laminated material; and
a cutting station for forming the carton blanks from the laminated material.

19. The system of claim 18, wherein the foaming station includes a storage tank supplying an adhesive to a foamer.

20. The system of claim 18, wherein the foamed adhesive is a water-based emulsion.

21. The system of claim 20, wherein the foamed adhesive emulsion is selected from the group consisting essentially of ethylene vinyl acetate and polyvinyl acetate emulsions.

22. A system for forming, folded and glued cartons as the cartons are moved along a processing path through a product packaging line, comprising:
a first folder for engaging and folding a first series of carton flaps to a closed position;
an adhesive applicator station having at least one extrusion head for applying an extruded foamed adhesive in a desired pattern to at least one carton flap;
a second folder for engaging and folding a second series of carton flaps to a closed position; and
a laminating station downstream from the second folder for applying a compression force to the folded carton flaps to set the foamed adhesive applied to the carton flaps.
